(19) United States
(12) Patent Application Publication
(10) Pub. No.: US 2015/0324495 A1
(43) Pub. Date: Nov. 12, 2015

(54) System and Method for Translating Data from Data-Driven Engineering Drawings to Determine Regulatory Applicability

(71) Applicant: Environmental Intellect, LLC, Laramie, WY (US)

(72) Inventors: Shane Edward Kling, Pearland, TX (US); Jess Michael Askey, Fort Collins, CO (US)

(73) Assignee: Environmental Intellect, LLC, Laramie, WY (US)

(21) Appl. No.: 14/802,806

(22) Filed: Jul. 17, 2015

Related U.S. Application Data
(62) Division of application No. 14/450,264, filed on Aug. 3, 2014.
Application No. 14/450,264 is a continuation of application No. 12/753,631, filed on Apr. 2, 2010, now abandoned.
(60) Provisional application No. 61/166,186, filed on Apr. 2, 2009.

(51) Int. Cl. G06F 17/50

(52) U.S. Cl. CPC G06F 17/50

(57) ABSTRACT

A system and method for performing environmental, health, and safety regulation compliance assessments, recordkeeping, and reporting from “data-driven” engineering drawings (i.e., intelligent P&ID/PFD systems). EH&S regulations include but are not limited to USEPA Clean Air Act regulations, such as Leak Detection and Repair (LDAR), Benzene Waste Operations NESHAP (BWON), and the Greenhouse Gas Mandatory Reporting Rule (GHG MRR), as well as regulations administered by OSHA, such as Process Safety Management (PSM). These regulations are commonly enforced within such industries as the petroleum refining, petrochemical, chemical, upstream oil and gas, or other related manufacturing industries. In order to determine compliance with those regulations, information stored within the engineering CAD drawing is queried in terms of specific drawing entities, or the components that comprise a specific process which is detailed on said drawing (i.e., pipes, equipment, instrumentation, etc), in order to determine compliance with those regulations. If it is determined that there is non-compliance with EH&S regulations, then solutions are provided via tabular reporting, object colorization of drawing entities, as well as through an interface that shares information by reading and/or writing functions with independent upstream and downstream computer data systems. This software-based solution provides the petroleum, petrochemical, chemicals, alternative fuels, energy, and related manufacturing solutions to an increasing number of environmental, health, and safety regulatory compliance challenges. Information gathered from “data-driven” engineering drawings is used to determine applicability of regulations to the particular structure EH&S compliance records and reports are generated with information in a format suitable for use in reporting to local, State, and Federal regulatory agencies.

### CROSS-REFERENCE TO RELATED APPLICATIONS

The present application is a divisional of U.S. application Ser. No. 14/450,264, filed Aug. 3, 2014, which is a continuation of U.S. application Ser. No. 12/753,631, filed Apr. 2, 2010, and claims the benefit of U.S. Application No. 61/166,186, filed Apr. 2, 2009; each of which is herein incorporated by reference, in the entirety, for all purposes.

### BACKGROUND

1. Field of the Invention

The present invention is generally directed to regulatory compliance, and more particularly to providing a solution to addressing environmental, health, and safety compliance challenges.

2. The Relevant Technology

Local, State, and Federally-mandated environmental, health, and safety regulations apply to various industries in the United State and throughout the world. For example, these regulations apply to petroleum refining operations, chemical and gas production plants, oil and gas pipeline and storage facilities, which affect day-to-day operational practices, modifications to manufacturing processes, pollution control technologies, etc.

Compliance with these regulations historically has been accomplished through a manual system to determine applicability of regulations, and whether there is compliance with those regulations. In addition, antiquated software programs, such as spreadsheets, have also been used to track compliance with these regulations. Compliance with recordkeeping and reporting requirements across a variety of EH&S regulations is traditionally achieved by accessing a host of data systems and manually inputting this information into a template that satisfies regulatory requirements. In practice, many records and reports, if not stored electronically, are organized and archived in hard-copy format. However, each of these traditional techniques lack the sophistication or complexity to easily and efficiently determine regulation applicability at a particular facility or operation, and to track compliance with regulations over a long period of time, especially if the facility or operation is large and complex. That is, these traditional methods are unreliable.

### SUMMARY OF THE INVENTION

Embodiments of the present invention provide for systems and methods for performing environmental, health, and safety (EH&S) regulation compliance assessments, recordkeeping, reporting and information sharing from data-driven engineering drawings. Embodiments of the present invention apply to general petroleum refining, petrochemical, chemical, pharmaceutical manufacturing, and other energy production industries, or any facility that fall under requirements of the United States Environmental Protection Agency (USEPA) or the Occupational Safety and Hazards Administration (OSHA), and/or any EH&S regulation enforcement body EH&S regulations include but are not limited to USEPA Clean Air Act regulations, such as Leak Detection and Repair (LDAR), Benzene Waste Operations NESHAP (BWON), and the Greenhouse Gas Mandatory Reporting Rule (GHG MRR), as well as regulations administered by OSHA, such as Process Safety Management (PSM). Information extracted from database-driven, engineering computer aided design (CAD) drawings is used to determine applicability of regulations to the particular process facility, in terms of the engineering CAD drawing, or the components that comprise a specific process which is detailed on said drawing (i.e., pipes, equipment, instrumentation, etc.), in order to determine compliance with those regulations. In embodiments, the correlated environmental properties and determinations are presented through a user interface by contextual color screen and printable highlighting, detailed and summary reports, and a drilldown user interface. The correlated and calculated properties and determinations can be shared with other computer software applications or networks. The data output for the present invention is provided to an end-user via a computer network or by accessing the world wide web (i.e., internet).

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of the architecture of an engineering CAD drawing (i.e., intelligent P&ID/PFD) system architecture, in accordance with one embodiment of the present invention.

FIG. 2 illustrates an exemplary process flow diagram (PFD), which provides a visual representation in summary of a particular manufacturing operation or process, in accordance with one embodiment of the present invention.

FIG. 3 is a piping and instrumentation diagram (P&ID), which provides a visual representation in detail of a particular manufacturing operation or process, in accordance with one embodiment of the present invention.

FIG. 4 is an illustration of the architecture of an intelligent P&ID/PFD system showing the process flow logic of generating EH&S regulatory compliance assessments, record keeping, reporting, and sharing from data-driven engineering drawings, in accordance with one embodiment of the present invention.

FIG. 5 is an illustration of a collection of engineering CAD drawings that may exist at any facility, which provides a visual representation of the hierarchy of information that is present within said drawings, in accordance with one embodiment of the present invention.

FIG. 6 is a PFD illustrating an exemplary entity relationship, or component properties, of a specific equipment object which is subject to requirements of USEPA leak detection and repair (LDAR) regulation, in accordance with one embodiment of the present invention.

FIG. 7 is an illustration of an exemplary tabular data view of a collection of process stream data extracted from engineering CAD drawings, which is presented in terms of applicability evaluation EH&S regulations, in accordance with one embodiment of the present invention.

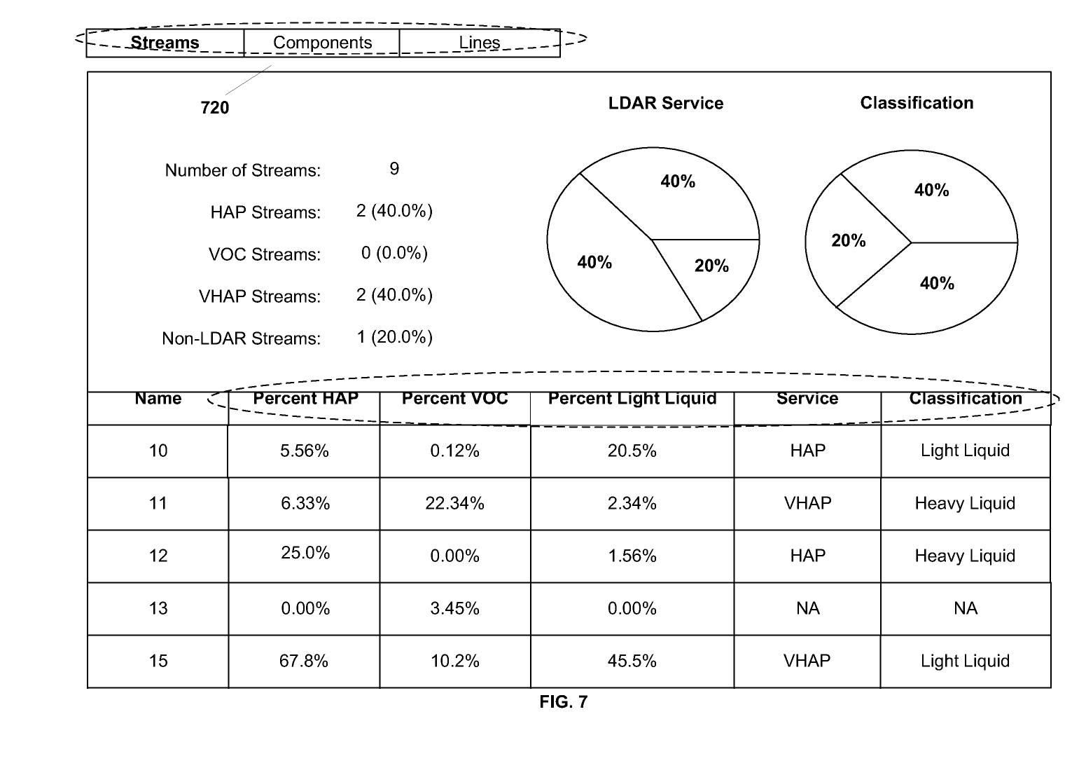

FIG. 8 is an illustration of a P&ID with colorization of drawing entities, which indicates applicability with EHS regulations as determined by the system and method discussed herein, in accordance with one embodiment of the present invention.

FIG. 9 is an illustration of an exemplary tabular “drilldown” navigation feature of the data output schema, in accordance with one embodiment of the present invention.

FIG. 10 is an illustration of an exemplary internet browser view that provides access to output data of the “intelligent P&ID/PFD system” to an end-user independent of connectivity to an engineering CAD drawing via a computer network or storage system, in accordance with one embodiment of the present invention.

FIG. 11 is an illustration of an exemplary tabular data view of a collection of process stream data extracted from engineering CAD drawings and the functionality to provide an end-user with the ability to manually set applicability with an EH&S regulation (i.e., a mechanism for overriding data output from the engineering CAD drawing), in accordance with one embodiment of the present invention.

FIG. 12 is an illustration of the exemplary relationships that exist between a summary PFD and a related, detailed P&ID, as well as the process of “data-mapping logic,” as achieved by a Data-Mapping Engine, in accordance with one embodiment of the present invention.

FIG. 13 is an illustration an electronic software interface that allows EH&S regulation compliance data to be shared by reading or writing program data with upstream and downstream data systems, in accordance with one embodiment of the present invention.

### DETAILED DESCRIPTION

Reference will now be made in detail to the preferred embodiments of the present invention, a method and system for performing environmental, health, and safety regulation (EH&S) compliance assessments, recordkeeping, and reporting from “data-driven” engineering drawings. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention are capable of extracting information stored within “data-driven” engineering drawings and software and/or hardware implementations with engineering expertise to achieve regulatory compliance. In particular, embodiments of the present invention relate to methods and systems for analyzing and correlating data extracted from an engineered drawing and/or an engineered drawing database. Embodiments of the present invention rely upon data-driven engineering drawings (i.e., engineering CAD drawings and/or intelligent PFD/P&ID systems) to calculate applicability with EH&S regulations by cross correlating operational process data, chemical speciation, component connectivity data, or any other related data source needed for computation as defined in the EH&S regulation documents provided by the enforcing agency.

Embodiments of the present invention can be implemented on a software program for processing data through a computer system. The computer system can be a personal computer, notebook computer, server computer, mainframe, networked computer (e.g., router), handheld computer, personal digital assistant, workstation, and the like. This program or its corresponding hardware implementation is operable for determining regulatory applicability and compliance. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “creating,” “providing,” or the like refer to the actions and processes of a computer system, or similar electronic computing device, including an embedded system, that manipulates and transfers data represented as physical (i.e., electronic) quantities within the computer system's registers and memories into other data similarly represented as physical quantities within the computer system memories or registers or other such information storage, transmission or display devices.

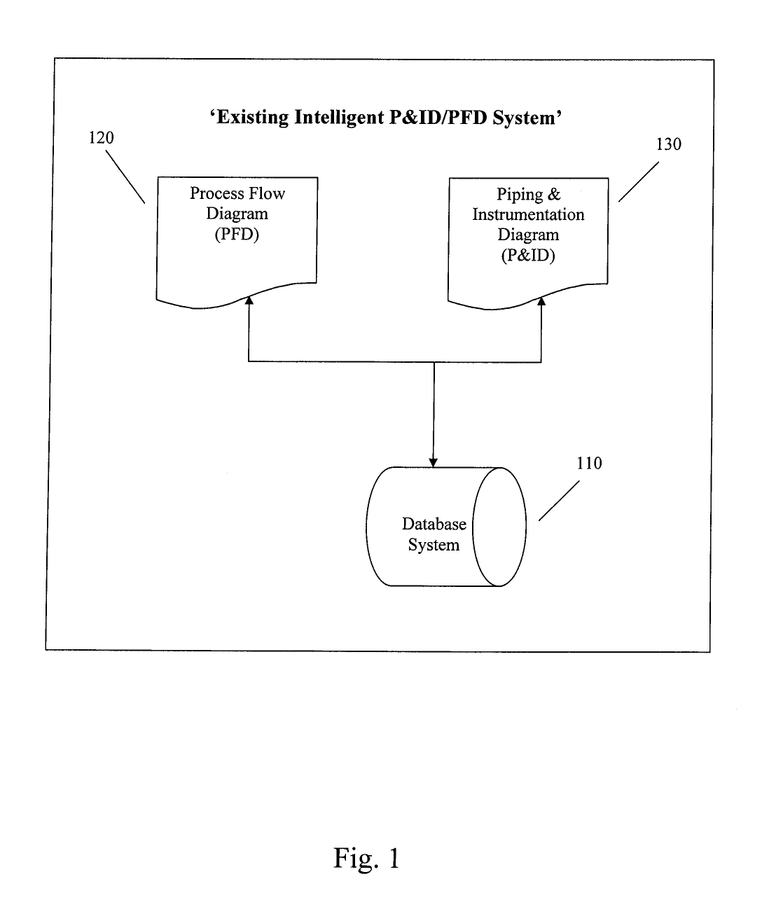

Engineering CAD drawings represent a fundamental medium capable of storing significant amounts of process facility operation and design data. These drawings support the master plan for engineering specifications, operating conditions, chemical makeup and component connectivity. In a data-driven engineering drawing or “Intelligent P&ID/PFD System” of FIG. 1, this operation and design data is stored within a common Database System 110 supporting all facility drawings, and is not limited to being stored within the individual drawings themselves.

Engineering CAD drawings represent a fundamental medium capable of storing significant amounts of process facility design data. These drawings support the master plan for engineering specifications, operating conditions, chemical makeup and component connectivity. In a data-driven or ‘Intelligent’ CAD system of FIG. 1, this design data is stored within a common database 110 supporting all drawings, and is not stored within the individual drawings themselves.

Engineered CAD drawings typically consist of two types of drawings, Process Flow Diagrams (PFDs) 120 which provide a summary view of a process and generally describe stream flows between major systems and/or components within a process. A more detailed set of corresponding drawings is commonly referred to as Piping & Instrumentation Diagrams (P&ID's) 130, and contains details of individual process components and pipes in greater specificity in order to specifically quantify all aspects of an operational or manufacturing process in existence at a facility.

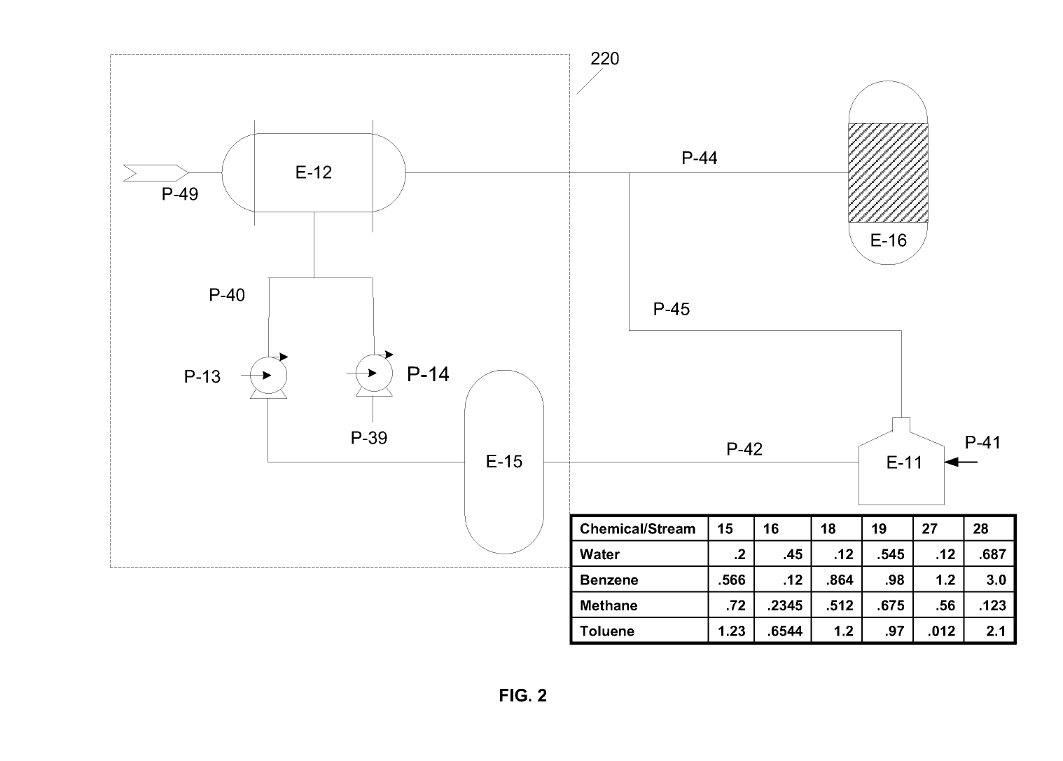

With reference to FIG. 2, there is illustrated a visual representation of an exemplary process flow diagram (PFD), or a summary of the process vessels, equipment, as well as, stream and chemical relationships 210 that describe the general relationship between the entities comprising said operational or manufacturing process (alternatively referred to herein as “process summary”) 220.

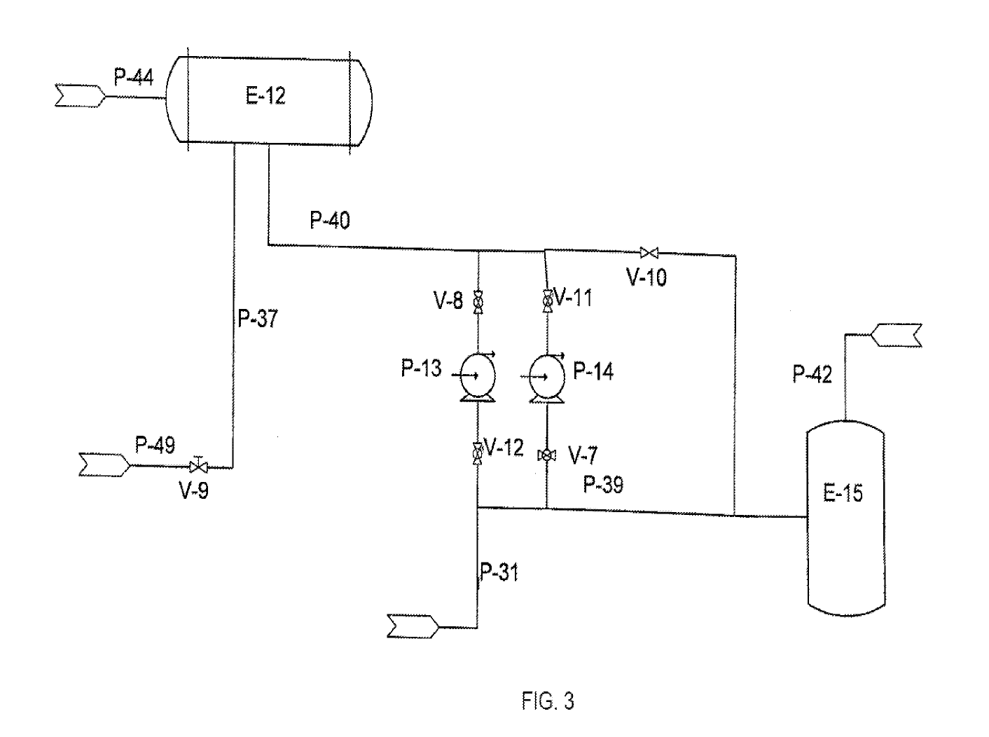

FIG. 3 illustrates an exemplary P&ID that describes in detail the master plan for engineering specifications, operating conditions, chemical makeup and component connectivity (alternatively referred to herein as “process details”) 310. With reference to the “process summary” 220 present within a PFD there is a relationship that exists with the process details 310 contained within a specific P&ID. That is, a PFD will generally summarize several P&IDs, and several P&IDs are required to fully understand a PFD. As shown in FIG. 2, a subset of the “process summary” 220 of a PFD is a representation of a “process details” 310 of a P&ID in FIG. 3.

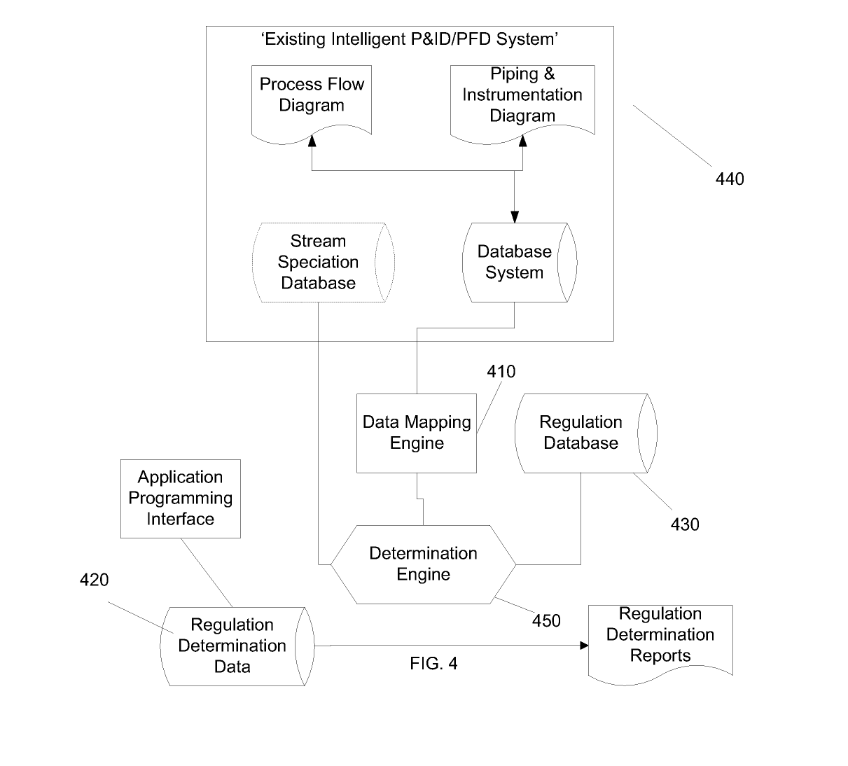

FIG. 4 is an intelligent P&ID/PFD system 440 showing EH&S regulation compliance assessments, recordkeeping, reporting, and information sharing from data-driven engineering drawings, in accordance with one embodiment of the present invention. More particularly, intelligent P&ID/PFD systems 440 exist in several proprietary systems, and these various systems rely upon different information storage mechanisms and data organizational schema. Embodiments of the present invention support and work upon these various systems by having a common “Data Mapping Engine” that translates the underlying data points into a common structure for an EH&S regulator determination engine, which is illustrated in FIG. 4. For example, a specific EH&S regulation may have a requirement based specifically for a facility's combustion source (i.e., “boiler”); however, various intelligent P&ID/PFD systems 440 may store the data that represent a boiler in different underlying database structures. Additionally, based upon a defined regulatory property, the semantics might be distinct in how these objects are related to each other. The Data Mapping Engine 410 provides functionality for reading data from the intelligent P&ID/PFD system 440 and translating those terms into EH&S regulation-specific objects and properties, or “regulation determination data” 420, in terms of the defined requirements of a specific EH&S regulation, which is programmatically stored in regulation database 430. This data schema allows the next phases of the invention to function universally with the database system 110 of an intelligent P&ID/PFD system 440.

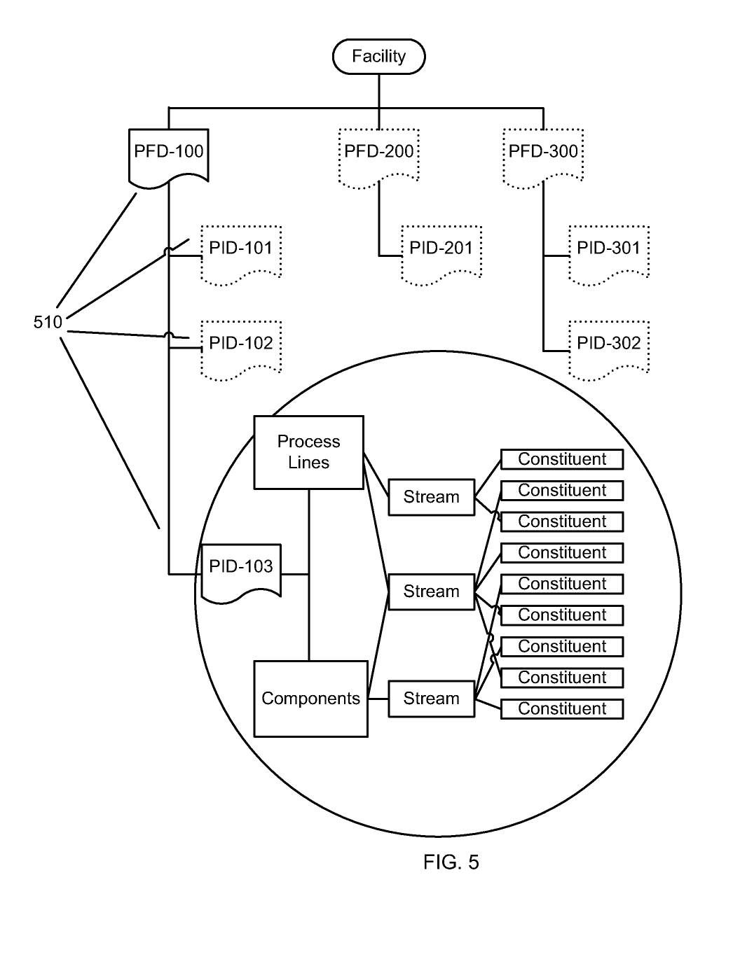

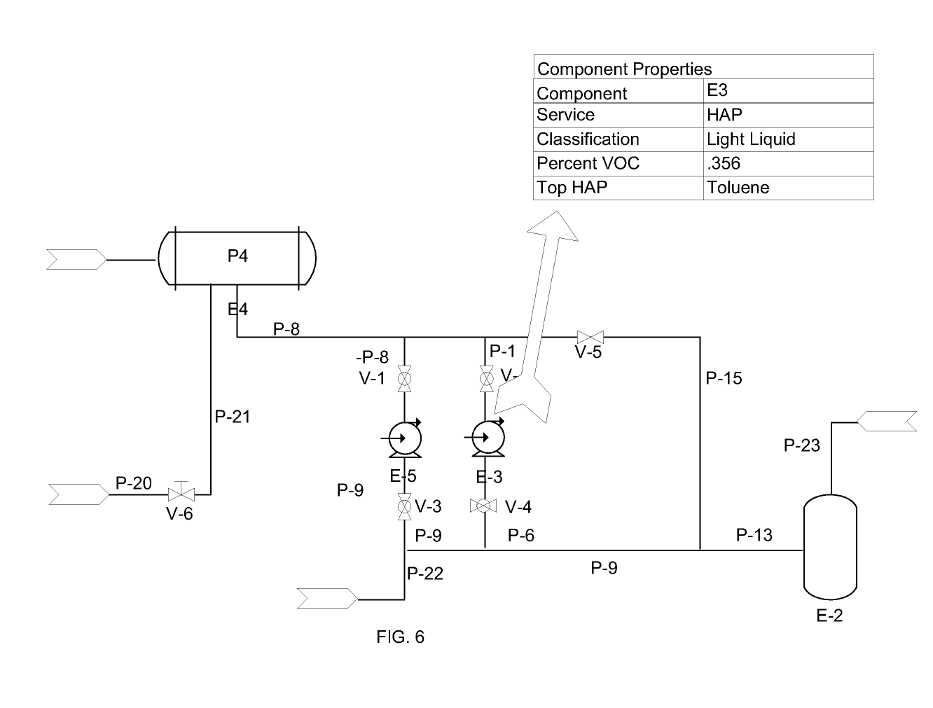

In embodiments of the present invention, an EH&S regulation compliance determination engine 450 of FIG. 4 is capable of characterizing the common objects presented by the Data Mapping Engine 410, to evaluate potential of applicability with defined EH&S regulation requirements, and creates a newly-defined set of objects and complex relationships 420 to describe the process facility in terms of a specific EH&S regulation. This process is referred to hereafter as developing an “environmental fingerprint” within one or more PFDs and/or one or more P&IDs. More specifically, the EH&S determination engine 450 is executed by a set of algorithms, which is based upon applicability criteria that is defined in a specific EH&S regulation database 430. A common scenario in the USEPA Leak Detection and Repair (LDAR) regulation is a relationship chain characterized by the data that relates PFDs to P&IDs and Process Streams to Chemical Species to Process Equipment (alternatively referred to herein as “drawing entities”) 510, as illustrated in FIG. 5. After computation, the “environmental fingerprint” is then known stored within the system and can be translated to the drawing entities 510 within the intelligent P&ID/PFD system 440. Embodiments of the present invention allow display of those regulatory calculated data by individual selection of equipment to display the attributes, or component properties 610 of that particular piece of equipment, as shown in FIG. 6.

One embodiment of the present invention is implemented by characterizing information specifying the calculated EH&S regulation properties 710 in terms of the data elements stored within an intelligent PFD/P&ID system 440, such as the streams, components and lines 720 from a computerized drawing, which is stored in a database system 110.

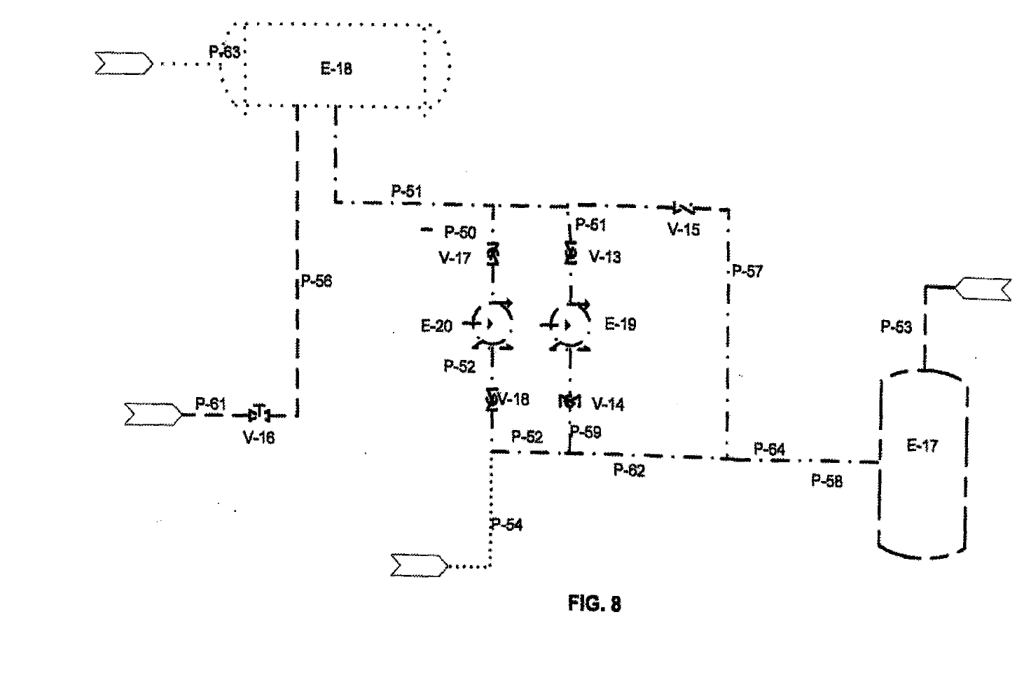

One embodiment of the present invention enables the visual propagation of the process summary 220 and process detail 310 in conjunction with the calculated EH&S regulation properties 710 in terms of the data elements stored within an intelligent PFD/P&ID system 440. That is, the dataset and engineering drawing are generated in a co-dependent environment, and these data computations can be output into a tabular reporting format or can be represented visually via direct colorization of drawing entities 810 by calculated EH&S regulation properties as shown in FIG. 8.

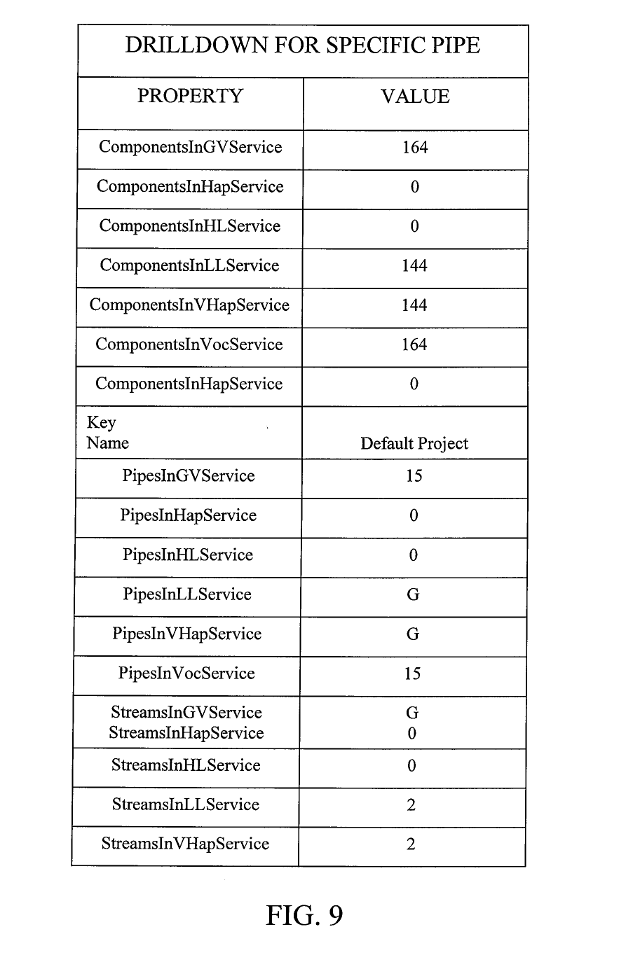

One embodiment of the present invention describes an organizational data schema that enables relational “drilldown” of data elements comprising the process summary 220 and process details 310 via a user interface as shown in FIG. 9. In particular, the “drilldown” is a system of hierarchal data elements 910 that are inter-related as a function of the operational or manufacturing process that is being described by the PFD and/or P&ID, which summarizes calculated EHS regulation properties 710 of the specific drawing entities 510.

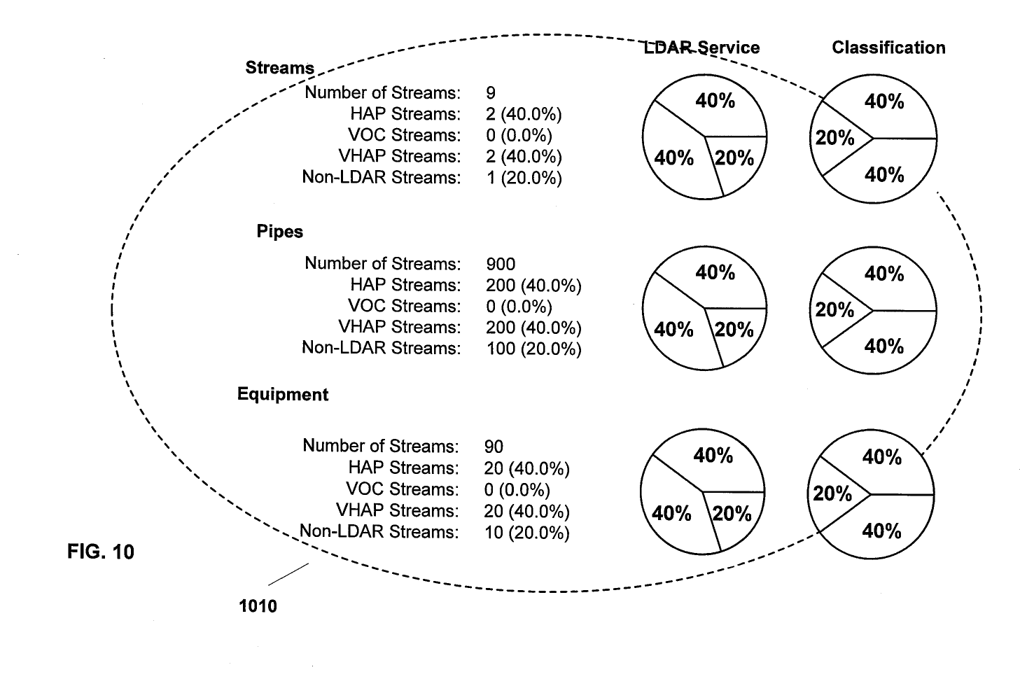

In an embodiment, a user interface exists within the present invention, which can be operated on a users' own computer (e.g., a desktop or laptop workstation) independent of a connection to the specific engineering CAD drawing system by accessing the world wide web (i.e., internet). Calculated EH&S regulation data is presented within an internet-browser interface 1010 that is characterized by the Data Mapping Engine of the intelligent P&ID/PFD system 440. Dependent on location networking, this allows sharing of data-driven CAD system data to users not having CAD-specific applications or systems installed on their workstation as shown in FIG. 10.

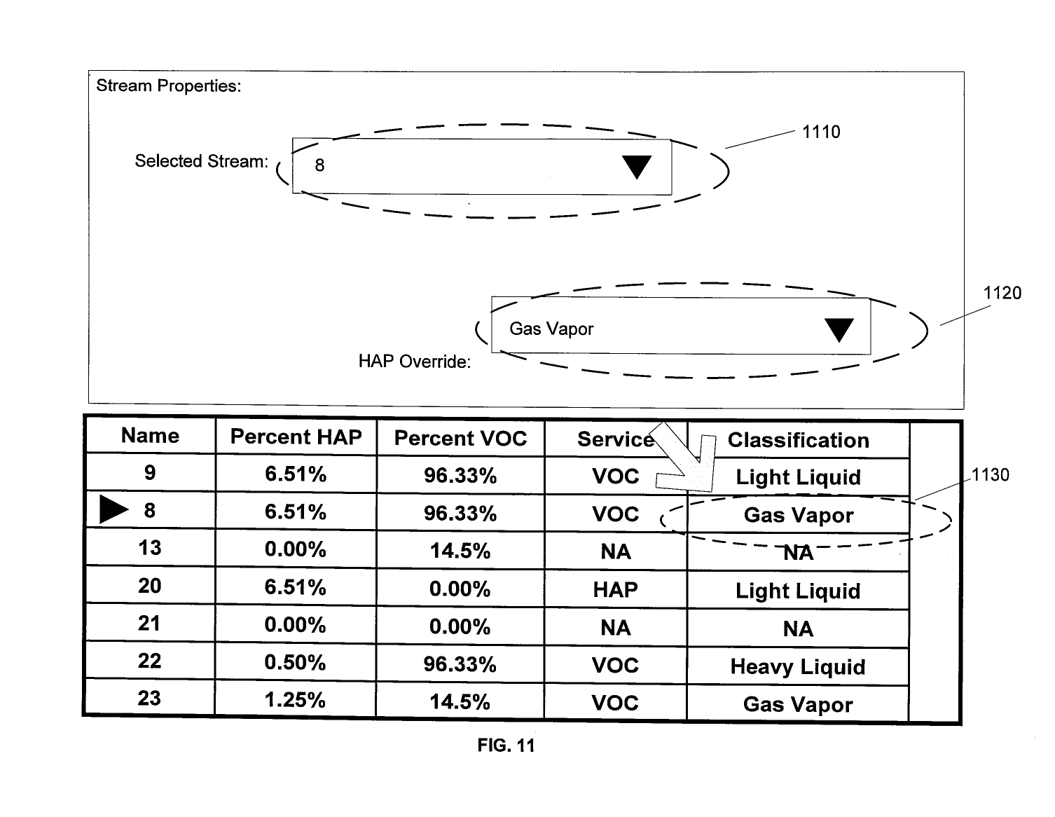

To manage rule exceptions FIG. 11 and/or data anomalies, the software computational method additionally allows a user to “override” calculated regulatory properties 1110 and physical properties by manually setting the EH&S regulation applicability 1120. If subsequent calculations or analysis within the Determination Engine utilize those properties, then the “user override” value will be used which may change the outcome of the calculated property 1130.

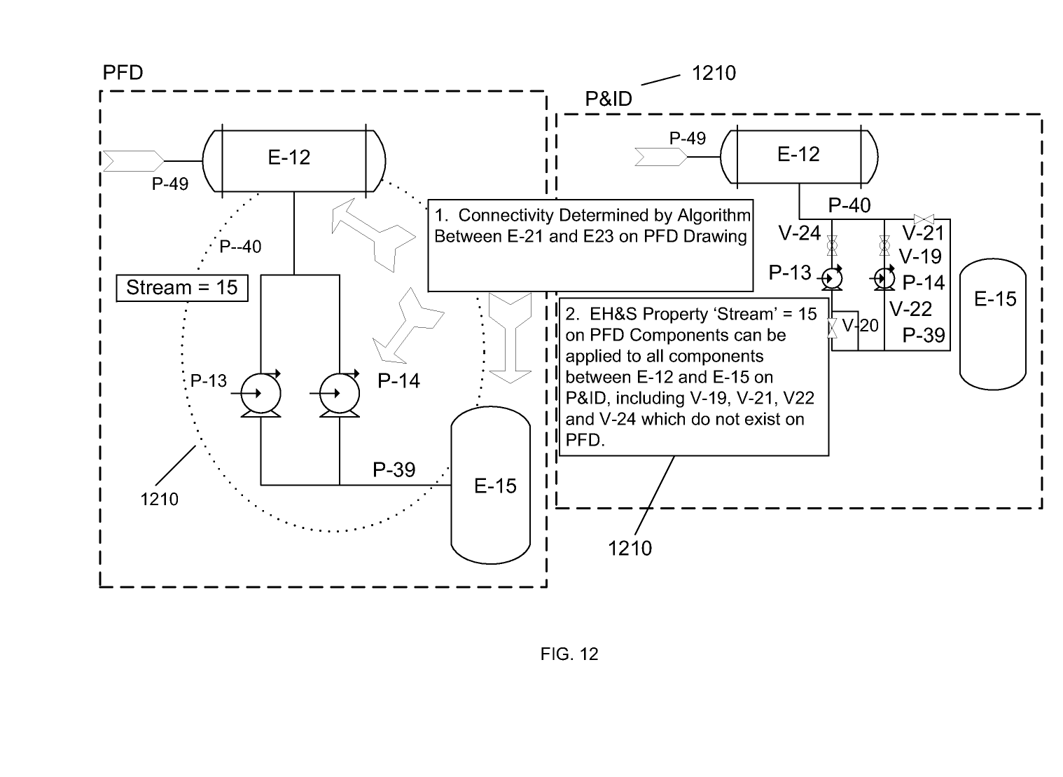

Embodiments of the present invention contain functionality to define and understand the relationships between PFDs 120 and P&IDs 130, and allow programmatic assignment of regulatory properties from general PFD structures to the more complex P&ID structures. A connectivity algorithm such as Dykstra's Shortest Path, or A* (A-Star), is implemented in embodiments in order to map components from P&IDs to the larger representation on the PFD of FIG. 12. Other connectivity algorithms are also contemplated in other embodiments. For example, a user may change a regulatory property on the general PFD, and this change will automatically update the regulatory property value to associated components on the P&ID 1220 utilizing a connectivity algorithm 1230.

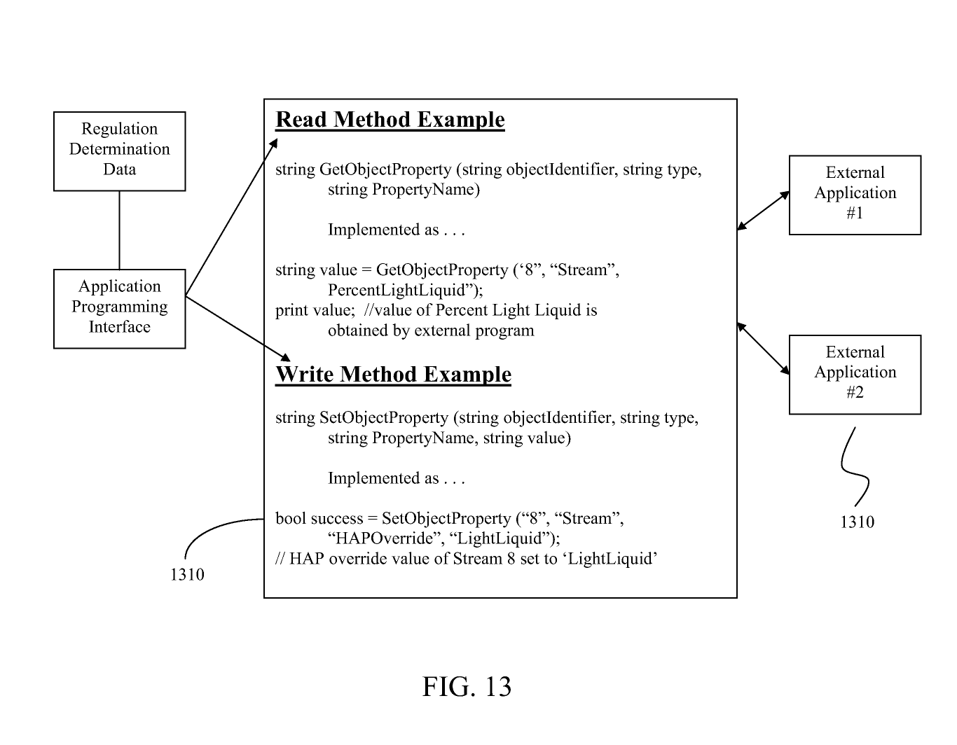

Additionally, one embodiment of the present invention provides an electronic software interface as shown in FIG. 13 that allows EH&S regulation compliance data to be shared by reading and/or writing functions 1310 with independent upstream and downstream computer data systems. In one embodiment, the Application Program Interface (API) fits a standard model of software allowing external systems 1320 to interface with EH&S regulation compliance properties, as needed.

Accordingly, embodiments of the present invention are capable of extracting information stored within “data-driven” engineering drawings and software and/or hardware implementations with engineering expertise to achieve regulatory compliance.

Methods and systems for performing environmental, health, and safety regulation compliance assessments, recordkeeping, and reporting, from “data-driven” engineering drawings are thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments.

What is claimed is:

1. An automated, computer-implemented method comprising:
selecting a regulated equipment item having a Leak Detection and Repair (LDAR) requirement;
associating the regulated equipment item with an identification number;
accessing a data-driven piping and instrumentation diagram (P&ID) representing a multiplicity of process streams, the process streams comprising a plurality of piping equipment objects and a plurality of chemical species;
locating the identification number in the data-driven P&ID;
identifying a process stream in the data-driven P&ID containing the identification number;
grouping, into a process stream group, all components in the process stream connected to the regulated component;
assigning the LDAR requirement to the components in the process stream group;
retrieving LDAR data for the components in the process stream group;
generating a report of components and LDAR applicability data for the process stream group;
updating the data-driven P&ID with annotations of identification numbers for LDAR-regulated equipment.

2. The method of claim 1, further comprising: excluding data on equipment items, not in the process stream group, from the report of components and LDAR applicability data for the process stream group.

3. A non-transitory computer readable medium comprising instructions stored thereon, that when executed on a processor, performs the steps of:
identifying a regulated equipment item having a Leak Detection and Repair (LDAR) requirement and an identification number;
accessing a data-driven piping and instrumentation diagram (P&ID) representing a multiplicity of process streams, the process streams comprising a plurality of piping equipment objects and a plurality of chemical species;
locating the identification number in the data-driven P&ID;
identifying a process stream in the data-driven P&ID containing the identification number;
grouping, into a process stream group, all components in the process stream connected to the regulated component;
assigning the LDAR requirement to the components in the process stream group;
retrieving LDAR data for the components in the process stream group;
generating a report of components and LDAR applicability data for the process stream group;
updating the data-driven P&ID with annotations of identification numbers for LDAR-regulated equipment.
